(19) United States
(12) Patent Application Publication
(10) Pub. No.: US 2008/0043283 A1
(43) Pub. Date: Feb. 21, 2008

(54) Image forming apparatus, image forming method, and computer program product

(76) Inventor: Kenichi Takeda, Kanagawa (JP)

Correspondence Address: DICKSTEIN SHAPIRO LLP, 1825 EYE STREET NW, Washington, DC, 20006-5403, US

(21) Appl. No.: 11/882,722

(22) Filed: Aug. 3, 2007

(30) Foreign Application Priority Data
Aug. 21, 2006 (JP) 2006-224591

(51) Int. Cl. G06F 3/12

(52) U.S. Cl. 358/1.15; 358/401

(57) ABSTRACT

An image forming apparatus determines whether orientation of an image is specified in the instructions associated with the print data. If orientation is not specified, the orientation (Portrait or Landscape) is set based on printing conditions provided in the associated instructions. The printing conditions can be document size, rotation angle, or print layout.

### CROSS-REFERENCE TO RELATED APPLICATIONS

The present application claims priority to and incorporates by reference the entire contents of Japanese priority document, 2006-224591 filed in Japan on Aug. 21, 2006.

### BACKGROUND OF THE INVENTION

1. Field of the Invention

The present invention relates to setting of orientation of an image when printing an image in an image forming apparatus.

2. Description of the Related Art

A typical image forming apparatus prints an image on a recording medium based on the printing conditions set by a user. The printing conditions include an orientation of the paper, (i.e., portrait or landscape. However, some of the print data do not allow setting of the orientation. For example, the portable document format (PDF) files do not allow setting of the orientation. Such print data are printed in a fixed orientation, which is one of the above two orientations. However, this might not result in a print output intended by the user. For example, a post-processing condition that acts as an instruction to provide a post-process such as stapling or punching to the recording media (hereinafter, “printed materials”) could be included in the printing conditions. Such a process might be provided at positions that are not intended by the user. Also, a traditional technique has been suggested to avoid meaningless print results by determining the feasibility of the format settings by comparing format settings of a document (printing conditions) and capacity of a printer, which is an image forming apparatus, and changing ones determined to be infeasible. A conventional technology has been disclosed in, for example, Japanese Patent Application Laid-Open No. 2005-107845.

However, the conventional technology has a problem that the printing result may not necessarily be as intended by the user, because, the printing conditions are modified depending on the capacity of a printer. Moreover, because it lacks the ability to specify a proper orientation, the print data might not be output appropriately if the orientation is not specified for the print data.

### SUMMARY OF THE INVENTION

It is an object of the present invention to at least partially solve the problems in the conventional technology.

According to an aspect of the present invention, there is provided an image forming apparatus that prints out an image of print data subjected to a printing operation on a recording medium based on instructions specifying printing conditions of such print data. The image forming apparatus includes an orientation determining unit that determines whether an orientation of the print data is specified in the instructions; an orientation setting unit that sets, upon the orientation determining unit determining that the orientation has not been specified, the orientation of the print data based on the printing conditions in the instructions; and a controlling unit that enables printing of the image of the print data on the recording medium in the orientation set by the orientation setting unit.

According to another aspect of the present invention, there is provided an image forming method including printing out an image of print data subjected to a printing operation on a recording medium based on instructions specifying printing conditions of such print data. The image forming method includes determining whether an orientation of the print data is specified in the instructions; setting, upon it is determining at the determining that an orientation has not been specified, the orientation of the print data based on the printing conditions in the instructions; and controlling including enabling printing of the image of the print data on the recording medium in the orientation set at the setting.

According to another aspect of the present invention, there is provided a computer program product that causes a computer to implement the above image forming method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic drawing of an image forming system according to an embodiment of the present invention;

FIG. 2 is a block diagram of an image forming apparatus shown in FIG. 1;

FIG. 3 is a block diagram of an orientation setting unit shown in FIG. 2;

FIG. 4 is a flowchart of a printing process performed by the image forming apparatus;

FIG. 5 is a flowchart of a first orientation setting process performed by the image forming apparatus;

FIGS. 6A and 6B are schematic drawings for explaining the relationship among a document size, rotation angle, and orientation of print data;

FIG. 7 is a flowchart of a second orientation setting process performed by the image forming apparatus;

FIGS. 8A, 8B, and 8C are schematic drawings for explaining the relationship between the number of pages printed per sheet and orientations of print data;

FIG. 9 is a flowchart of a first image rotation process performed by the image forming apparatus;

FIGS. 10A, 10B, and 10C are drawings for explaining the first image rotation process shown in FIG. 9;

FIG. 11 is a flowchart of a second image rotation process performed by the image forming apparatus;

FIGS. 12A and 12B are drawings for explaining the second image rotation process shown in FIG. 11; and

FIG. 13 is a block diagram of the hardware configuration of the image forming apparatus.

### DETAILED DESCRIPTION OF THE PREFERRED EMBODIMENTS

Exemplary embodiments according to the present invention will be described below in greater detail with reference to the accompanying drawings.

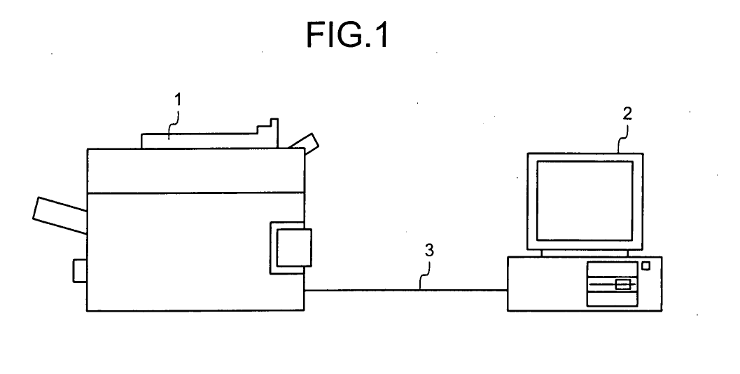

FIG. 1 is a schematic drawing of an image forming system according to an embodiment of the present invention. The image forming system includes an image forming apparatus 1 and a terminal 2 that are interconnected via a cable 3 in a communicative manner. It should be understood that the example shown in this figure is not intended to limit the number of devices included in the image forming system, and the interconnections can also be made either in 1:N or N:N configuration.

The image forming apparatus 1 is a multifunction product having multiple functions such as a copy function or a printer function. A copier function is a function that includes reading a document as print data and printing out an image of the print data to a sheet-like recording medium such as a paper. A printer function is a function that includes receiving print data and associated instructions, which specify printing conditions of the print data to be printed, from the terminal 2, and printing out an image of the print data based on the instructions. “Print data” means printable digital data such as document or image data.

The terminal 2 is an information processing terminal, such as a personal computer (PC). The terminal 2 transmits print data specified by a user to the image forming apparatus 1 via the cable 3. A user can specify various printing conditions relating to printing process of the print data, e.g., document size, rotation instruction, multiple-pages-per-sheet printing. These instructions are sent to the image forming apparatus 1 along with the print data. “Printing conditions” means various setting items relating to printing process of the print data, and their examples include document size of the print data, instruction to rotate the print data (rotation angle), the number of pages to be printed per sheet, binding position on the recording media. Such conditions might also include those relating to a post-process such as sorting, stapling, punching (holes) or folding of the recording media recorded with the print data.

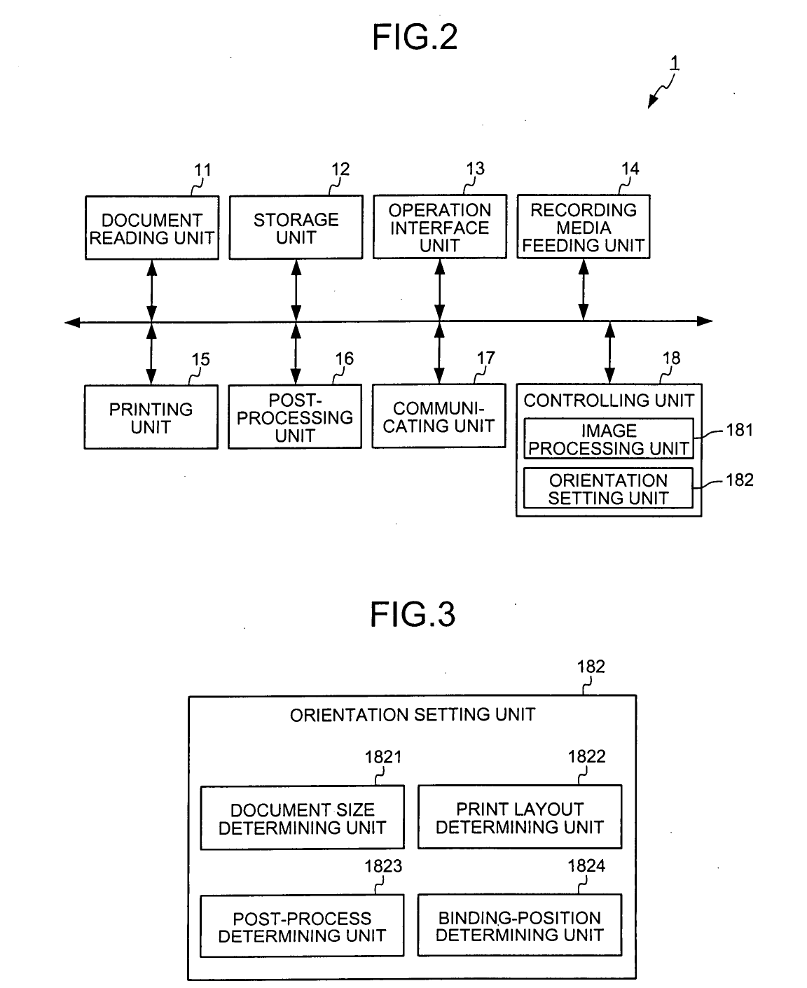

FIG. 2 is a block detailed diagram of the image forming apparatus 1. The image forming apparatus 1 includes a document reading unit 11, a storage unit 12, an operation interface unit 13, a recording media feeding unit 14, a printing unit 15, a post-processing unit 16, a communicating unit 17, and a controlling unit 18.

The document reading unit 11 irradiates the document with the reading light, reads the image of the document and converts it to digital image data by photoelectrically converting the reflected light using a photoelectric transducer such as a charge coupled device (CCD). The digital image data is written into the storage unit 12 as print data. The document reading unit 11 may be provided with an auto document feeder (ADF), and the documents fed from the ADF are read successively and written into the storage unit 12 as print data, one for each page.

The storage unit 12 is a storage medium such as a random access memory (RAM) or a hard disk, and stores therein print data read by the document reading unit 11 or print data received from the terminal 2 via the communicating unit 17 along with associated instructions.

The operation interface unit 13 has different keys and/or touch panels, and a user performs various operations required to operate the image forming apparatus 1 by operating these operation keys and/or touch panels. Especially, the inputs instructions related to printing conditions by operating the operating interface unit 13. The input printing conditions are stored in the storage unit 12 as a part of the instruction data.

The recording media feeding unit 14 feeds recording media, which are maintained in paper trays (not shown), to the printing unit 15 via a feeder (not shown). Paper sheets of various sizes and various orientations are stacked in the paper trays in advance, and the controlling unit 18 controls which a recording medium of which size and which orientation is to be fed to the printing unit 15 based on the print data.

The printing unit 15 prints out the image of the print data stored in the storage unit 12 on the recording media fed from the recording media feeding unit 14, based on the corresponding instructions under the control of the controlling unit 18.

The post-processing unit 16 performs post-processes on the printed materials supplied from the printing unit 15 via feeder (not shown) under the control of the controlling unit 18. Examples of the post-processes include sorting the printed materials under a given rule, stapling or punching them at a post-process (binding or punching) position specified by the instructions, or double- or triple-folding the printed materials, the latter forming a Z-like shape (Z-folding).

The communicating unit 17 communicates data with an external device, for example, with the terminal 2 via network N.

The controlling unit 18 controls the overall operation of the image forming apparatus 1. The controlling unit 18 includes a read only memory (ROM) (not shown) and a microcomputer (not shown). The control programs for the image forming apparatus 1 are stored in the ROM, and the microcomputer executes the control programs read from the ROM with data temporarily stored in RAM.

The controlling unit 18 also functions as an orientation determining unit, an orientation setting unit, a post-process determining unit, binding-position determining unit, and a controlling unit, by executing control programs (hereinafter, “image forming programs”) relating to printing operations of print data, with such control programs stored in the ROM. Upon executing the control programs, the controlling unit 18 outputs control signals corresponding to the instructions input via the communicating unit 17 or the operation interface unit 13 to control the operations of the document reading unit 11, the storage unit 12, the operation interface unit 13, the recording media feeding unit 14, the printing unit 15, the post-processing unit 16, and the communicating unit 17, so that a given printing operation is achieved by the image forming apparatus 1.

The controlling unit 18 includes an image processing unit 181 and an orientation setting unit 182. The image processing unit 181 refers to the instructions stored in the storage unit 12, and expands the print data into digital image data under the printing conditions specified in the instructions. The expanded digital image data is printed on the recording media by the printing unit 15 under the controls of the controlling unit 18. The expanded digital image data can be stored in the storage unit 12.

The orientation setting unit 182 determines whether an orientation is specified in the instructions associated with the print data to be printed. If not, a document size determining unit 1821 and a print layout determining unit 1822, shown in FIG. 3, set the orientation.

The document size determining unit 1821 sets the orientation suited for the print data to be printed based on the document size and rotation angle specified in the instructions.

The print layout determining unit 1822 sets the orientation suited for the print data to be printed based on the print layout specified in the instructions. “Print layout” means a layout used for printing such as one for printing multiple pages per sheet.

A post-process determining unit 1823 determines the feasibility of a post-process based on the post-process conditions specified in the instructions (positions where the post-processes are to be provided), the orientation set by the document size determining unit 1821 and the print layout determining unit 1822, and the mechanical limitations of the post-processing unit 16 as to the position where the post-processes is allowed. If it is determined infeasible, the image of the print data is rotated by a given angle to the point where the position specified in the instruction matches the position where the post-process is allowed, based on the position specified for such post-process and the positions where the post-process is allowed.

The “mechanical limitations of the post-processing unit 16 as to the positions where the post-processes are allowed” means positions or directions of the printed materials in which the post-processes cannot be provided because of the limitation in the specifications of a mechanism constituting the post-processing unit 16. The information indicating such a mechanical limitation is stored as limiting information in the storage unit 12 or a ROM (not shown) in advance. For example, if the arrangement of the post-processing mechanism limits the post-processes to be provided only at the rear edge of the printed material in relation to the feeding direction, information indicating so (i.e. the post-processes are allowed only at the rear edge, or not allowed at the front edge) will be stored as limiting information.

A binding-position determining unit 1824 determines if orientations of the images to be recorded on each side of a recording medium are consistent, based on the binding position specified in the instructions and the orientation set by the document size determining unit 1821 and the print layout determining unit 1822. If the orientations of the images are inconsistent, the image of the print data to be recorded on the back side of the recording medium is rotated by a given angle to a point where it become consistent with the image to be recorded on the front side.

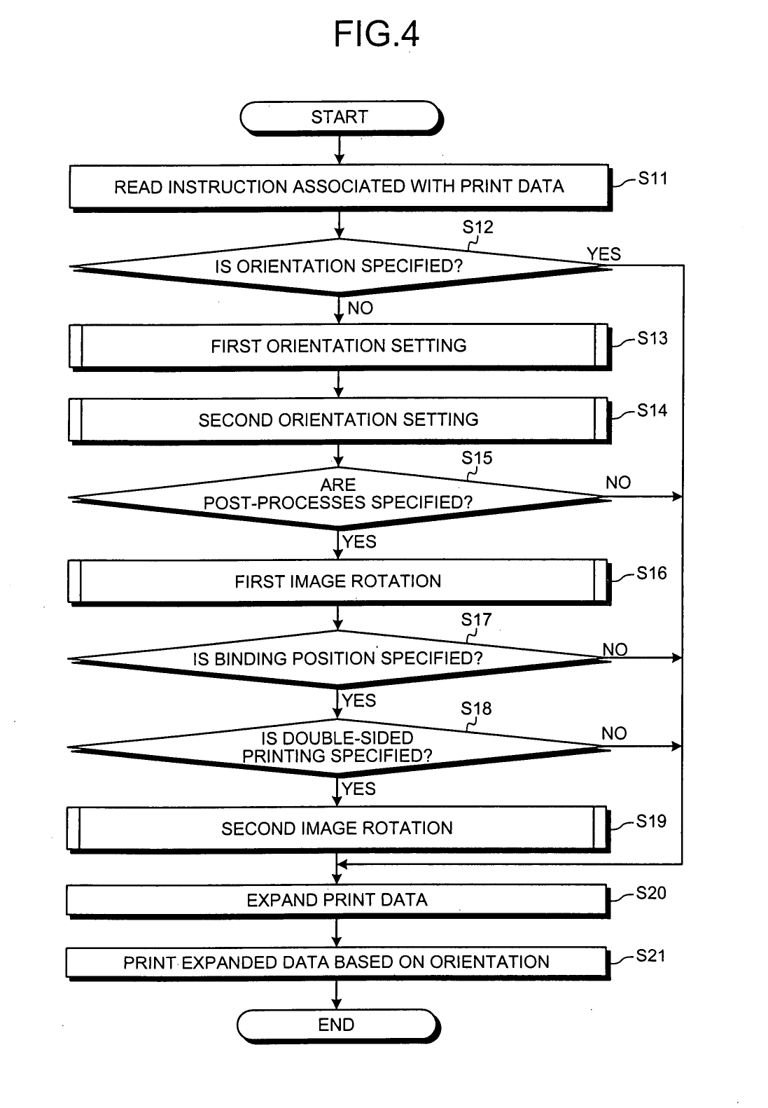

Printing operation performed by the image forming apparatus 1 will be described below. FIG. 4 is a flowchart of a printing process performed by the image forming apparatus 1. It should be noted that the operation is performed by executing an image forming program stored in the ROM (not shown) under the control of the controlling unit 18.

To begin with, the orientation setting unit 182 reads the instructions associated with the print data subjected to the printing from the storage unit 12 (Step S11), and determines whether an orientation is specified in the instructions (Step S12). If the orientation has been specified (YES at Step S12), the system control proceeds to Step S20. Then, the print data is printed at Steps S20 and S21 based on the specified orientation. Steps S20 and S21 shall be described later in detail.

If orientation is not specified (NO at Step S12), then the document size determining unit 1821 executes a first orientation setting (Step S13).

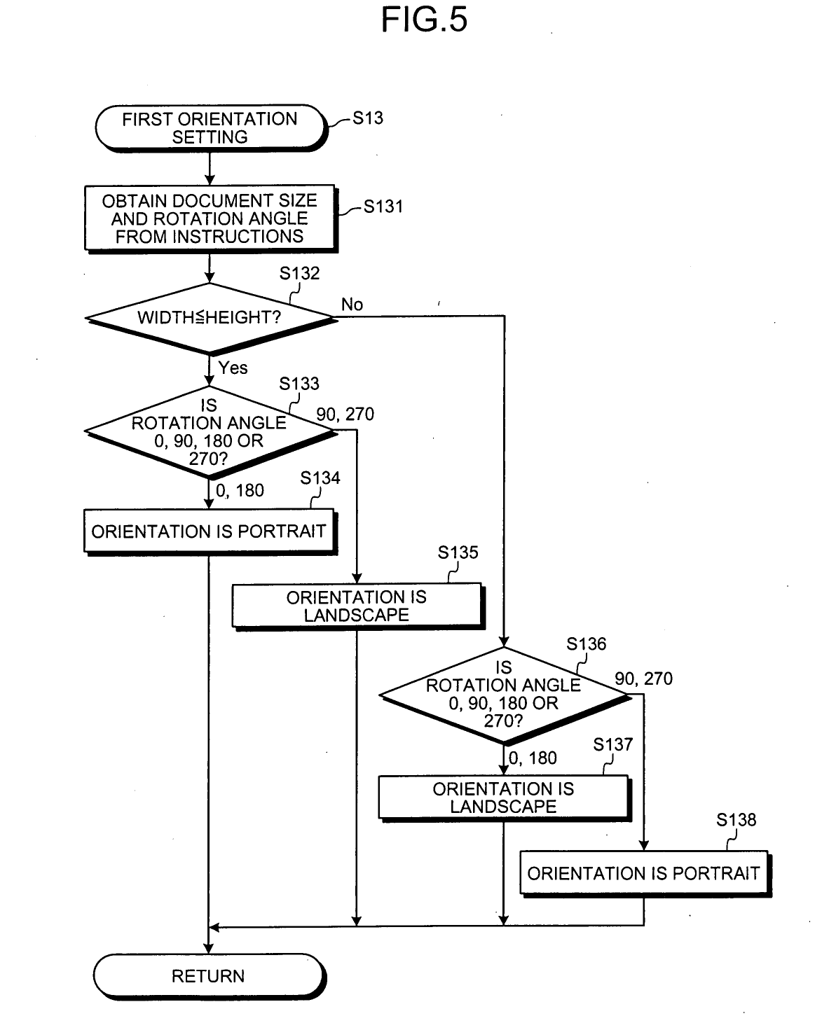

FIG. 5 is a flowchart of the first orientation setting process. To begin with, the document size determining unit 1821 obtains the document size and rotation angle from the instructions associated the print data to be printed (Step S131). Then, the document size determining unit 1821 compares the height and the width of the obtained document size (Step S132).

If the width is equal to or less than the height (width<height) (YES at Step S132), then the document size determining unit 1821 determines whether the rotation angle of the print data obtained from the instructions is any one of 0 degree, 90 degrees, 180 degrees, or 270 degrees (Step S133).

If the rotation angle is 0 degree or 180 degrees (“0, 180” at Step S133), then the document size determining unit 1821 sets the orientation to “Portrait” (Step S134), and the system control proceeds to Step S14 in FIG. 4. “Portrait” orientation means the paper size of a recording medium, which is to be recorded with the print data, having its long sides positioned vertically and short sides positioned horizontally, constituting a vertically long shape.

If the rotation angle is 90 or 270 degrees (“90, 270” at Step S133), the document size determining unit 1821 sets the orientation to “Landscape” (Step S135), and the system control proceeds to Step S14 in FIG. 4. “Landscape” orientation means the paper size of a recording medium, which is to be recorded with the print data, having its short sides positioned vertically and long sides positioned horizontally, constituting a horizontally long shape.

If the width is greater than the height (width>height) (NO at Step S132), then the document size determining unit 1821 determines whether the rotation angle of the print data obtained from the instruction is 0 degree, 90 degrees, 180 degrees, or 270 degrees (Step S136).

If the rotation angle is 0 or 180 degrees (“0, 180” at Step S136), then the document size determining unit 1821 sets the orientation to “Landscape” (Step S137), and the system control proceeds to Step S14 in FIG. 4.

If the rotation angle is 90 or 270 degrees (“90, 270” at Step S136), then the document size determining unit 1821 sets the orientation to “Portrait” (Step S138), and the system control proceeds to Step S14 in FIG. 4.

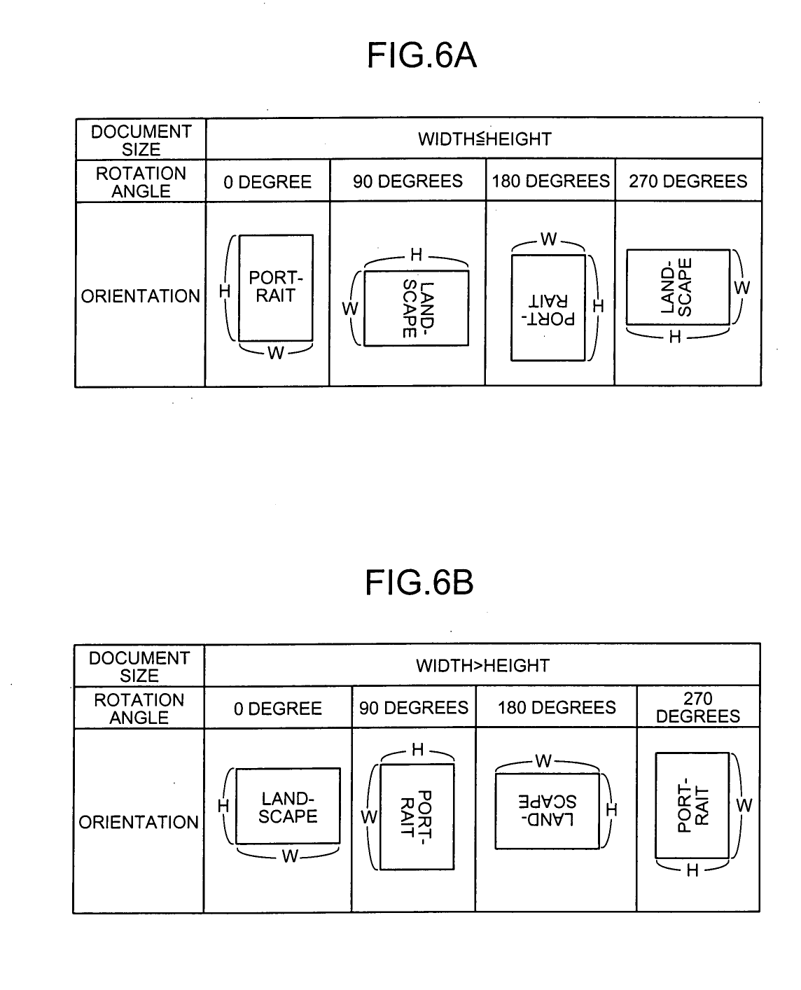

FIGS. 6A and 6B are schematic drawings for explaining the relationship among document size, rotation angle, and the orientation in the first orientation setting. As shown in FIG. 6A, for the print data where width<height, the orientation is set to “Landscape” or “Portrait”, depending on whether the rotation angle is 0 degree, 90 degrees, 180 degrees, or 270 degrees. Also, as shown in FIG. 6B, for the print data where width>height, the orientation is set to “Landscape” or “Portrait” in the same manner, depending on whether the rotation angle is 0 degree, 90 degrees, 180 degrees, or 270 degrees.

In this manner, the print data can be provided with an appropriate orientation even if the orientation is not specified in the instructions.

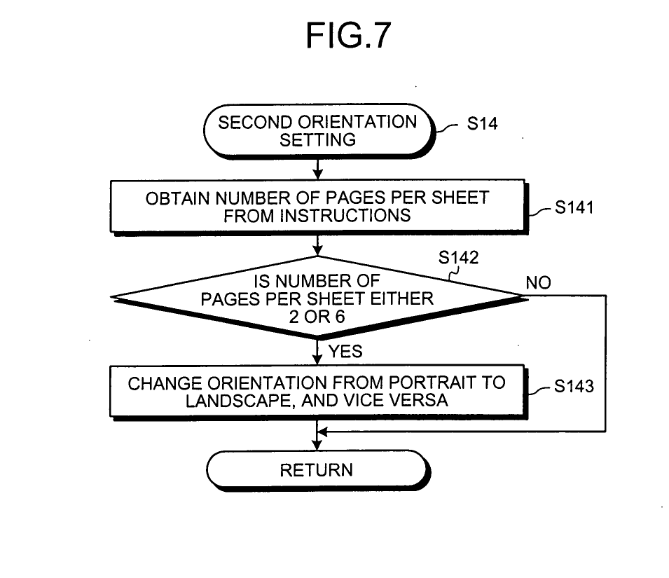

Referring back to FIG. 4, the print layout determining unit 1822 performs a second orientation setting in the subsequent Step S14. FIG. 7 is a flowchart of the second printing orientation setting process.

To begin with, the print layout determining unit 1822 obtains the number of pages to be printed per sheet (Step S141) from the instructions associated with the print data to be printed, and determines if the number of pages to be printed per sheet is 2, 6, or others (Step S142).

If the number of pages are 2 or 6 pages (YES at Step S142), then the print layout determining unit 1822 changes the orientation, which has been set in the first printing orientation setting, to a new setting (Step S143), and the system control proceeds to Step S15 in FIG. 4. Specifically, at Step S143, if the first orientation setting is “Portrait”, then the orientation is changed to “Landscape”; and if the first orientation setting is “Landscape”, then the orientation is changed to “Portrait”.

If the number of pages are other than 2 or 6 (NO at Step S142), then the system control proceeds to Step S15 in FIG. 4.

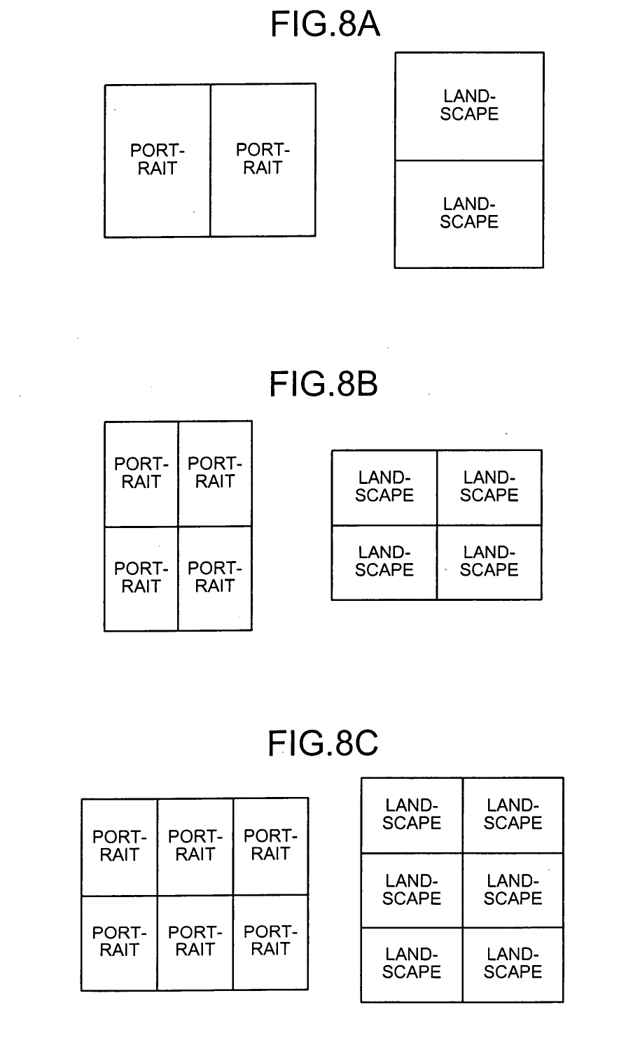

FIGS. 8A, 8B, and 8C are drawings for explaining the relationship between the number of pages to be printed per sheet and orientation to be set in the second orientation setting. FIG. 8A is a schematic drawing of a print layout with 2 pages per sheet, FIG. 8B is a schematic drawing of a print layout with 4 pages per sheet, and FIG. 8C is a schematic drawing of a print layout with 6 pages per sheet.

If the number of pages to be printed per sheet is two, the orientation is set in a manner described below. As shown in FIG. 8A, if two pages with “Portrait” orientation are printed on a single sheet, the overall layout created by these two pages will be “Landscape” like, having its short sides positioned vertically and long sides positioned horizontally. On the contrary, if two pages with “Landscape” orientation are printed on a single sheet, the overall layout created by these two pages will be “Portrait” like, having its long sides positioned vertically and short sides positioned horizontally. In other words, if the number of pages to be printed per sheet is two, by changing the orientation from “Portrait” to “Landscape” and vice versa, the data can be printed in an orientation suited for the print layout.

If the number of pages to be printed per sheet is four, the orientation is set in a manner described below. As shown in FIG. 8B, if four pages with “Portrait” orientation are printed on a single sheet, the overall layout created by these four pages will be “Portrait” like, having its long sides positioned vertically and short sides positioned horizontally. In a similar manner, if four pages with “Landscape” orientation are printed on a single sheet, the overall layout created by these four pages will be “Landscape” like, having its short sides positioned vertically and long sides positioned horizontally. In other words, if the number of pages to be printed per sheet is four, printing results with an appropriate orientation for the print layout can be obtained without changing orientation provided by the first orientation setting unit as it is.

If the number of pages to be printed per sheet is six, the orientation is set in a manner described below. As shown in FIG. 8C, if six pages with “Portrait” orientation are printed on a single sheet, the overall layout created by these six pages will be “Landscape” like, having its short sides positioned vertically and long sides positioned horizontally. On the contrary, if six pages with “Landscape” orientation are printed on a single sheet, the overall layout created by these six pages will be “Portrait” like, having its long sides positioned vertically and short sides positioned horizontally. In other words, if the number of pages to be printed per sheet is six, by changing orientation from “Portrait” to “Landscape” and vice versa, the data can be printed in an orientation suited for the print layout.

In this manner, an appropriate orientation can be set based on the print layout specified in the associated instructions, even if no orientation is specified in the instructions.

Referring back to FIG. 4, in the subsequent Step S15, the post-process determining unit 1823 determines whether any post-process is specified in the instructions of the print data to be printed (Step S15). If no post-processes have been specified (NO at Step S15), the system control proceeds to Step S20. Then the print data is printed at Steps S20 and S21 based on the orientation setting provided in the preceding steps.

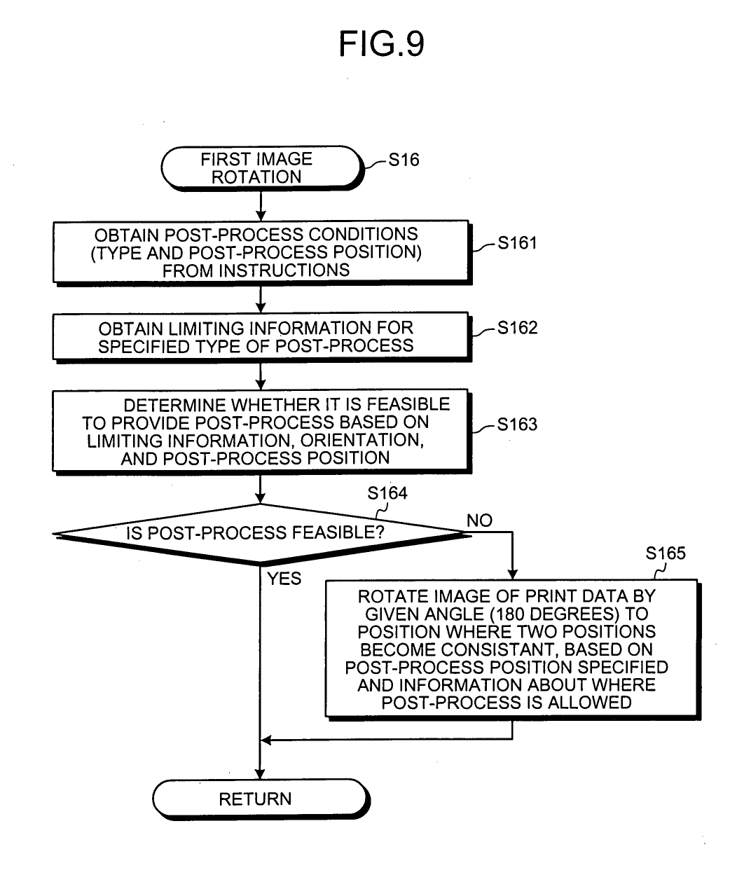

If some kind of post-processes are specified (YES at Step S15), then the post-process determining unit 1823 performs a first image rotation (Step S16). FIG. 9 is a flowchart showing an example of the first image rotation process. To begin with, the post-process determining unit 1823 obtains information related to post-process conditions from the instructions of the print data to be printed (Step S161). Here, it is assumed that at least a type of post-process (such as sorting, stapling, punching or folding) and a position to provide the post-process (post-process position) are specified in the instructions.

The post-process determining unit 1823 further obtains limiting information about for the post-process of the specified type from the storage unit 12 or the ROM (not shown) (Step S162), and determines if it is feasible to provide the post-process at the position specified, based on the limiting information obtained, the orientation set in the first and the second orientation settings, and post-process conditions obtained previously (Step S163).

If the post-process as specified is feasible (YES at Step S164), the system control proceeds to Step S17 in FIG. 4. Then, the print data is printed at Steps S20 and S21 based on the orientation provided previously.

On the contrary, if the post-process as specified is infeasible (No at Step S164), the post-process determining unit 1823 rotates the image of the print data by a predetermined angle (e.g., 180 degrees), based on the post-process position specified in the instructions and information about where post-process is allowed, to a position where these two positions become consistent (Step S165), and the system control subsequently proceeds to Step S17 in FIG. 4. The print data image may be rotated by the post-process determining unit 1823 itself or the image processing unit 181 adding (or subtracting) a given angle from the rotation angle specified in the instructions.

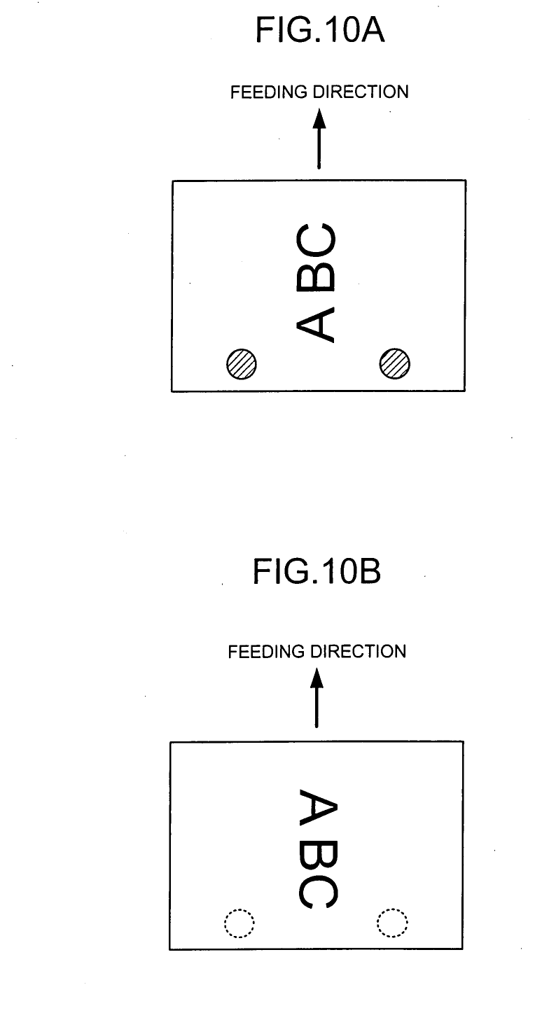

FIGS. 10A and 10B are schematic drawings for explaining the first image rotation. Here, by way of an example, it is assumed that the post-processing unit 16 can only punch holes at the rear edge of the printed materials in relation to the feeding direction, and information on such mechanical limitation is written into the storage unit 12 or the ROM (not shown) in advance. Also, in this specific example, it is assumed that an instruction for the post-process is given to punch holes at the left side of the image.

Under these assumptions, print results intended by the user can be obtained only if a printed material is fed in the direction (orientation) shown in FIG. 10A, with holes punched at left side of the print data image (ABC) as instructed.

However, if the printed material is fed in the direction (orientation) shown in FIG. 10B, the mechanical limitations of the post-processing unit 16 does not allow holes to be punched at the left side of the document data (that is, a front side in relation to the feeding direction). Furthermore, if holes are punched in the orientation shown in this figure, they are not in the positions intended by the user. In such a situation, the post-process determining unit 1823 concludes that the post-process as specified is infeasible, based on the limiting information related to punching by the post-processing unit 16, the orientation provided by the first and the second orientation settings, and post-process position (punching position) specified in the post-process conditions.

For the situation shown in FIG. 10B, based on the post-process position specified in the instruction and information where the post-processing unit 16 is capable of providing such process, the post-process determining unit 1823 rotates the image of the print data by 180 degrees to the position where both positions match, that is, to the position where the direction of the image of the print data is reversed. This achieves a setup shown in FIG. 10A, thereby preventing post-processes provided at the positions not intended by a user.

By rotating the image of the print data to the point where the post-process is possible, the post-process can be provided at a desired position even if it is determined infeasible to provide the post-processes under the post-process conditions specified in the instructions because of the mechanical limitation of the post-processing unit 16, thus achieving the appropriate printing results effectively.

Although the punching operation is used as an example of a post-process in this embodiment, the similar determination process may apply for other post-processes (such as sorting, stapling and folding) without limitation. It should be also understood that the image of the printed data is rotated by 180 degrees in this embodiment; however, rotations of any other angle are still possible. Other types of image processes are also possible, including enlarging or reducing the image in size, or moving it by a distance in order to achieve consistency between the mechanical limitation of the post-processing unit 16 and specified post-process conditions.

Referring back to FIG. 4, the binding-position determining unit 1824 references the instructions associated with the print data to be printed, and determines whether binding position is specified (Step S17). If a binding position is not specified (NO at Step S17), the system control proceeds to Step 20. Then, the print data is printed at Steps S20 and S21 based on the orientation provided previously. If the binding position is specified (YES at Step 17), then the binding-position determining unit 1824 further determines whether double-sided printing is specified in the instruction (Step S18).

If it is determined at Step S18 that double-sided printing is not specified (NO at Step S18), then the system control proceeds to Step S20. If double-sided printing is specified (YES at Step S18), then the binding-position determining unit 1824 proceeds to the operation of a second image rotation (Step S19).

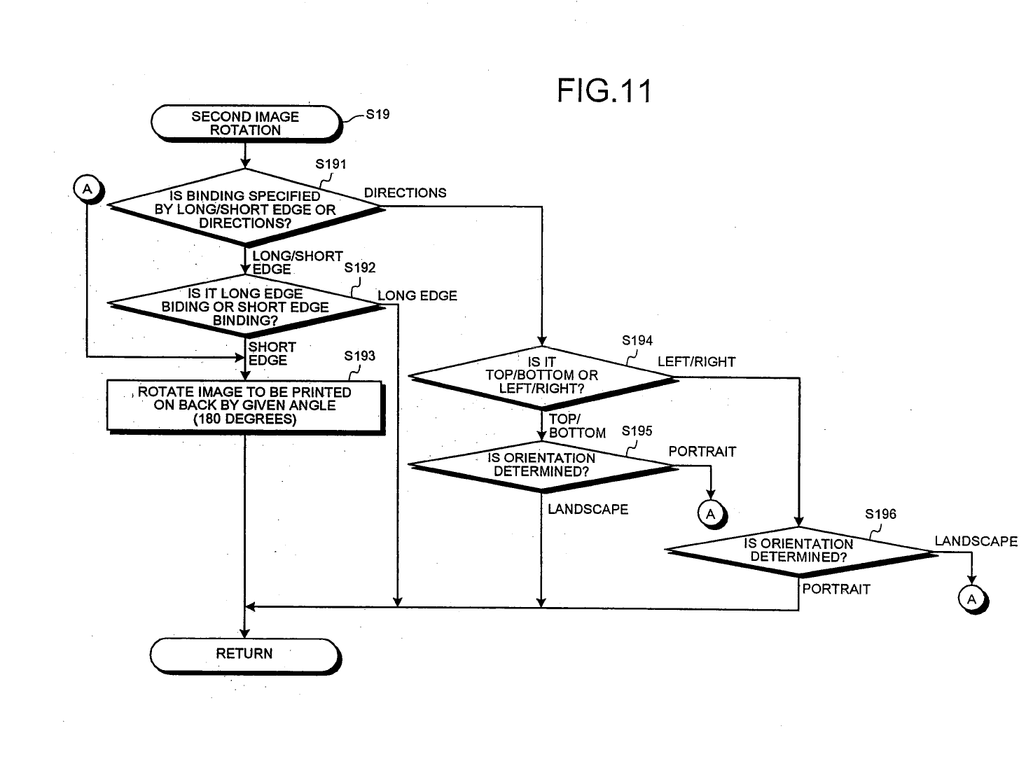

FIG. 11 is a flowchart of the second image rotation process. It is assumed here that, upon the printing unit 15 performing double-sided printing, one of the longer sides of the recording media is used as a reference axis for matching the directions of the images to be printed on front and back sides of the recording medium.

To begin with, the binding-position determining unit 1824 determines whether the specified binding position is by Long Edge Binding or Short Edge Binding, or by means of top, bottom, right or left (Step S191). “Long Edge Binding” herein means recording media (printed materials) to be bound at one of their longer sides, in relation to the printing direction, and “Short Edge Binding” means recording media to be bound at one of their shorter sides. “Top, bottom, right, or left” herein means the top, bottom, right, or left side with respect to the printing direction, that is, of the recording media (printed material), and specify binding at one of these sides.

If it is determined at Step S191 that Long or Short Edge Binding is specified (“Long/Short Edge” Step S191), then the binding-position determining unit 1824 further determines if Long Edge or Short Edge Binding is specified. If Long Edge Binding is specified, the binding-position determining unit 1824 assumes that the directions of the images to be recorded on each side of the recording medium are consistent (“Long Edge” at Step S192), and the system control proceeds to Step S20 in FIG. 4.

If Short Edge Binding is specified, the binding-position determining unit 1824 assumes that the directions of the images to be printed on each side of the recording medium are inconsistent (“Short Edge” at Step S192), and rotates the image of the print data that is to be printed on the back by a given angle (e.g. 180 degrees) to the position where it matches the direction of the image of the front (Step S193), and the operation subsequently continues to Step S20 in FIG. 4. The print data image may be rotated by the binding-position determining unit 1824 itself or in the image processing unit 181 adding (or subtracting) a given angle from the rotation angle specified in the instructions.

If it is determined at Step S191 that the instruction specifies the binding position top, bottom, right, or left (“directions” at Step S191), then the binding-position determining unit 1824 further determines whether the binding position is top, bottom, right, or left (Step S194). If the binding position is top or bottom (“top/bottom” Step S194), then the binding-position determining unit 1824 further determines the type of orientation set in the first and the second orientation settings (Step S195).

If the orientation is “Portrait”, then the binding-position determining unit 1824 considers that the directions of the images to be recorded on each side of the recording medium are inconsistent (“Portrait” at Step S195), and execute Step S193. Subsequently, the system control proceeds to Step S20 in FIG. 4. If the orientation is “Landscape”, then the binding-position determining unit 1824 considers that the directions of the images to be recorded on each side of the recording medium are consistent (“Landscape” at Step S195), and the system control proceeds to Step S20 in FIG. 4.

If the instruction specifies left or right (“left/right” at Step S194), then the binding-position determining unit 1824 further determines the type of orientation set in the first and the second orientation setting processes (Step S196).

If the orientation is “Landscape”, then the binding-position determining unit 1824 considers that the directions of the images to be recorded on each side of the recording medium are inconsistent (“Landscape” at Step S196), and executes the process of Step S193. Subsequently, the system control proceeds to Step S20 in FIG. 4. If the orientation is “Portrait”, then the binding-position determining unit 1824 considers that the directions of the images to be recorded on each side of the recording medium are consistent (“Portrait” at Step S196), and the system control proceeds to Step S20 in FIG. 4.

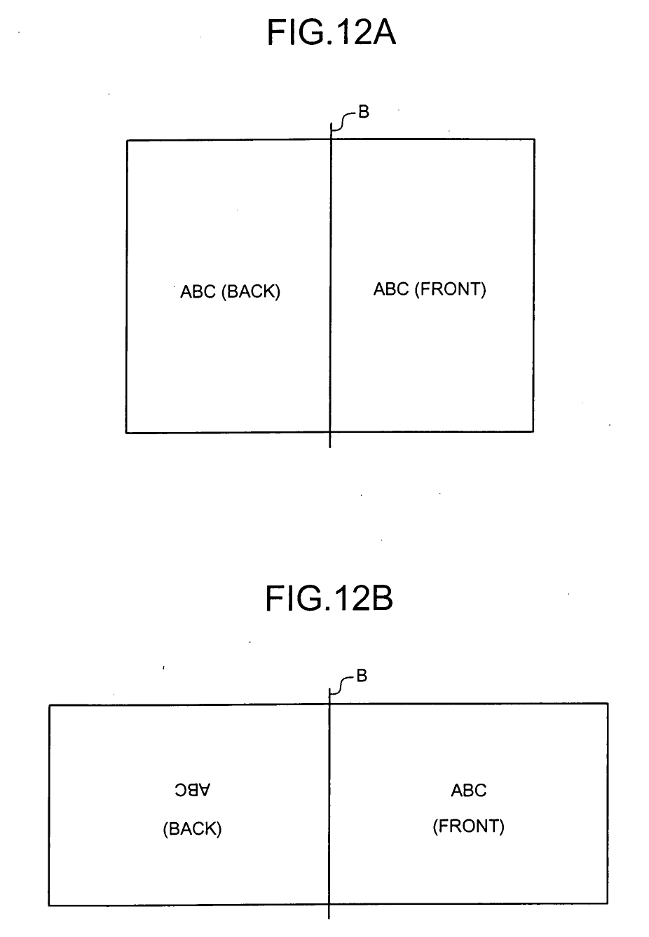

FIGS. 12A and 12B are drawings for explaining the second image rotation process. FIG. 12A is a schematic drawing for explaining how each side of a printed material is printed when an instruction of Long Edge Binding, or binding at left with the orientation of “Portrait” is specified. In response to such an instruction, the printing unit 15 prints out the images using one of the longer sides of the paper size as a reference axis to align the direction of the images to be printed on each side of the recording medium. Therefore, even if the printed materials are bound at the line B in the figure, the directions of the images printed on every page remain consistent.

FIG. 12B is a schematic drawing for explaining how each side of a printed material is printed when an instruction of Short Edge Binding, or binding at left with orientation of “Landscape” is specified. If the printed materials are to be bound at line B in the figure, the direction of the image on the front side will be reversed in relation to that on the back. Therefore, to resolve this inconsistency in the directions of the images to be printed on each side of the recording medium, when one of the following conditions is met, the image of the data to be printed on the back is rotated for 180 degrees in the second image rotation process, so that the direction of the image of the data to be printed on the back side coincide with that of the image of the data to be printed on the front side. Such conditions include; Short Edge Binding is specified; binding at the top or bottom is specified with “Portrait” orientation; or binding at the left or right is specified with “Landscape” orientation. In this manner, the directions of the images printed on every page remain consistent, providing desired printing results.

By rotating the image of the print data to the point where the directions of the images to be printed on each side of the printed material become consistent, the recording media can be bound at a binding position as desired, even if it is provided with an instruction specifying biding at positions that lead to inconsistency in the directions of the images to be printed on the each side of the recording medium, thus achieving the appropriate printing results effectively.

The present invention is not limited in any way by the above embodiment where double-sided printing is achieved by the printing unit 15 that aligns the directions of the images to be printed on each side of the recording medium using one of the longer sides of the paper size of the recording medium. Even if the double-sided printing is achieved according to another embodiment, the consistency in the directions of images to be printed on each side of the recording medium shall be determined in a similar manner as in the second image rotation, and the image to be printed on the back shall be rotated by a given angle to the point where the directions of the images to be printed on both sides of the recording medium become consistent.

Referring back to FIG. 4, in the subsequent Step S20, the image processing unit 181 expands the print data to be printed into a certain area in the storage unit 12 based on the orientation provided in the first and the second orientation setting processes and instructions associated with this print data (Step S20). The recording media feeding unit 14, the printing unit 15, the post-processing unit 16, and the like are operated under the controls of the controlling unit 18 to print the electronic digital image data that have been expanded in the storage unit 12 on the recording media (Step S21), and the entire process completes.

Therefore, according to the image forming apparatus 1, print data can be printed in an appropriate orientation even if the orientation is not specified.

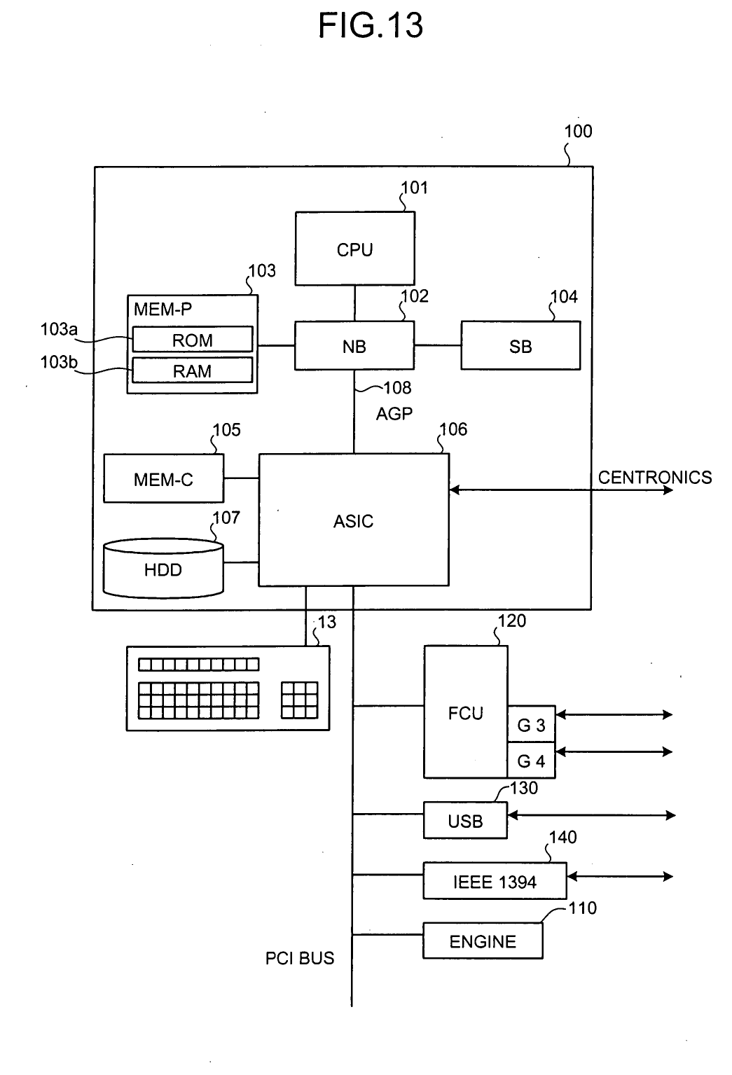

FIG. 13 is a block diagram of hardware architecture of the image forming apparatus 1. As shown in FIG. 13, the image forming apparatus 1 includes a controller 100 connected to an engine unit 110 via a peripheral component interconnect (PCI) bus. The controller 100 is responsible for controlling the entire image forming apparatus 1, and controlling the imaging, communication, and inputs from the operation interface unit 13. The engine unit 110 is a unit such as a printer engine connectable to a PCI bus, and examples include a black and white plotter, single drum color plotter, four-drum color plotter, scanner, or fax unit. In addition to the so-called engine unit such as a plotter, the engine unit 110 includes an image processing module for processes such as error diffusion or gamma transformation.

The controller 100 includes a CPU 101, a north bridge (NB) 102, a system memory (MEM-P) 103, a south bridge (SB) 104, a local memory (MEM-C) 105, an application specific integrated circuit (ASIC) 106, and a hard disk drive (HDD) 107. The NB 102 is interconnected with the ASIC 106 via an accelerated graphics port (AGP) bus 108. The MEM-P 103 further includes a read only memory (ROM) 103a and a random access memory (RAM) 103b.

The CPU 101 controls the entire image forming apparatus 1, and includes a chipset with the NB 102, MEM-P 103, and SB 104. The CPU 101 is connected to other devices through this chipset.

The NB 102 acts as a bridge for connecting the CPU 101 to the MEM-P 103, the SB 104, and the AGP 108, and has a memory controller, PCI master, and AGP target. The memory controller controls operations such as reading from and writing to the MEM-P 103.

The MEM-P 103 is a system memory used for storing and expanding the programs and data, and providing imaging function for the printer. The MEM-P 103 includes the ROM 103a and the RAM 103b. The ROM 103a is a read-only memory used for storing the programs and data, and the RAM 103b is a read-write memory used for expanding the programs and data and for imaging for the printer.

The SB 104 acts as a bridge that connects the NB 102 to the PCI devices and peripheral devices. The SB 104 is connected to the NB 102 via PCI bus, which, in turn, is connected to devices such as a network interface (I/F).

The ASIC 106 is an integrated circuit (IC) having hardware elements for processing images, and used for the purpose of image processing. It also acts as a bridge for connecting the AGP 108, the PCI bus, the HDD 107 and the MEM-C 105. The ASIC 106 includes a PCI target, an AGP master, an arbiter (ARB), a memory controller, a plurality of direct memory access controllers (DMACs), and a PCI unit. The ARB has the core function of the ASIC 106. The memory controller controls the MEM-C 105. The DMACs use hardware logics to perform operations such as image rotations. The PCI unit exchanges data with the engine unit 110 via PCI bus. The ASIC 106 is connected to a fax control unit (FCU) 120, a universal serial bus (USB) 130, and an IEEE (the Institute of Electrical and Electronics Engineers) 1394 interface 140 via PCI bus.

The MEM-C 105 is a local memory used as an image buffer for the copier function and as a code buffer. The hard disk drive (HDD) 107 is provided in order to store image data, programs, font data and forms.

The AGP 108 is a bus interface for a graphic accelerator card proposed to accelerate processing of graphics. The AGP 108 accelerates the graphic accelerator card by accessing the MEM-P 103 directly, with high throughputs.

Details about configuration and operation of the image forming apparatus according to the embodiment may be modified suitably without departing from the spirit or scope of the invention.

For example, in the embodiment, the image forming program to be executed in the image forming apparatus 1 is implemented in advance to devices such as a ROM, which is not shown in the figure. However, such an embodiment should not limit the scope of the present invention, and implementations such as installable and executable files stored in a computer-readable medium such as a CD-ROM, floppy disk (FD), CD-R, or digital versatile disk (DVD) are also possible.

According to the embodiment, the image forming program executed in the image forming apparatus 1 may be stored on a computer connected to a network such as the Internet, and downloaded over the network. Furthermore, the image forming program executed in the image forming apparatus 1 may also be delivered or distributed over a network such as the Internet. The image forming program executed in the image forming apparatus according to this embodiment has a modular architecture including all the units (the image processing unit 181, and the orientation setting unit 182 (including the document size determining unit 1821, the print layout determining unit 1822, the post-process determining unit 1823, and the binding-position determining unit 1824)). From the perspective of actual hardware, the CPU (processor) reads the image forming program from the ROM and executes it, loading each of the units to the main memory and generating the orientation setting unit 182 (including the document size determining unit 1821, the print layout determining unit 1822, the post-process determining unit 1823, and the binding-position determining unit 1824) in the main memory.

According to one aspect of the present invention, an appropriate orientation setting can be provided to print data even if it is not specified in instructions, having an effect of achieving the appropriate printing results.

Moreover, according to another aspect of the present invention, desired post-processes can be achieved even if it is not feasible to provide such processes under the conditions specified by instructions, having an effect of achieving the appropriate printing results.

Furthermore, according to still another aspect of the present invention, the recording media can be bound at a desired position even if binding at positions specified in the instruction could cause inconsistency in the directions of the images to be printed on each side of a recording medium, having an effect of achieving the appropriate printing results.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus that prints out an image of print data subjected to a printing operation on a recording medium based on instructions specifying printing conditions of such print data, the image forming apparatus comprising:
an orientation determining unit that determines whether an orientation of the print data is specified in the instructions;
an orientation setting unit that sets, upon the orientation determining unit determining that the orientation has not been specified, the orientation of the print data based on the printing conditions in the instructions; and
a controlling unit that enables printing of the image of the print data on the recording medium in the orientation set by the orientation setting unit.

2. The image forming apparatus according to claim 1, wherein the orientation setting unit sets the orientation of the print data based on a document size specified as a printing condition in the instructions.

3. The image forming apparatus according to claim 1, wherein the orientation setting unit sets the orientation of the print data based on a rotation angle specified as a printing condition in the instructions.

4. The image forming apparatus according to claim 1, wherein the orientation setting unit sets the orientation based on print layout specified as a printing condition in the instructions.

5. The image forming apparatus according to claim 1, further comprising:
a post-processing unit that performs a post-process on the recording medium printed with the print data; and
a post-process determining unit that determines whether the post-process specified in the instructions is feasible based on a position specified in the instructions associated with the print data to provide the post-process, the orientation being set by the orientation setting unit, and mechanical limitation in the post-processing unit as to the position for the post-process, and in determining the post-process to be infeasible, rotates the image of the print data by a given angle, based on the position specified in the instructions for such post-process and the position where such post-process by the post-processing unit is feasible, to the point where the position specified in the instructions matches the position where the post-process is feasible.

6. The image forming apparatus according to claim 1, further comprising a binding-position determining unit that determines whether the directions of the images to be printed on each side of the recording medium are consistent based on a binding position specified in the instructions and the orientation set by the orientation setting unit, and in determining the directions to be inconsistent, rotates the image of the print data to be printed on the back side of the recording medium by a given angle to the point where the directions of the images to be printed on both sides of the recording medium become consistent.

7. An image forming method including printing out an image of print data subjected to a printing operation on a recording medium based on instructions specifying printing conditions of such print data, the image forming method comprising:
determining whether an orientation of the print data is specified in the instructions;
setting, upon it is determining at the determining that an orientation has not been specified, the orientation of the print data based on the printing conditions in the instructions; and
controlling including enabling printing of the image of the print data on the recording medium in the orientation set at the setting.

8. The image forming method according to claim 7, wherein the setting includes setting the orientation of the print data based on a document size specified as a printing condition in the instructions.

9. The image forming method according to claim 7, wherein the setting includes setting the orientation of the print data based on a rotation angle specified as a printing condition in the instructions.

10. The image forming method according to claim 7, wherein the setting includes setting the orientation based on print layout specified as a printing condition in the instructions.

11. The image forming method according to claim 7, further comprising:
performing a post-process on the recording medium printed with the print data; and
determining whether the post-process specified in the instructions is feasible based on a position specified in the instructions associated with the print data to provide the post-process, the orientation being set at the setting, and mechanical limitation in the post-processing as to the position for the post-process, and in determining the post-process to be infeasible, rotating the image of the print data by a given angle, based on the position specified in the instructions for such post-process and the position where such post-process is feasible, to the point where the position specified in the instructions matches the position where the post-process is feasible.

12. The image forming method according to claim 7, further comprising determining whether the directions of the images to be printed on each side of the recording medium are consistent based on a binding position specified in the instructions and the orientation set at the setting, and in determining the directions to be inconsistent, rotates the image of the print data to be printed on the back side of the recording medium by a given angle to the point where the directions of the images to be printed on both sides of the recording medium become consistent.

13. A computer program product that causes a computer to implement an image forming method including printing out an image of print data subjected to a printing operation on a recording medium based on instructions specifying printing conditions of such print data, the computer program causing the computer to execute:
determining whether an orientation of the print data is specified in the instructions;
setting, upon it is determining at the determining that an orientation has not been specified, the orientation of the print data based on the printing conditions in the instructions; and
controlling including enabling printing of the image of the print data on the recording medium in the orientation set at the setting.
